(19) United States
(12) Patent Application Publication
(10) Pub. No.: US 2013/0145248 A1
(43) Pub. Date: Jun. 6, 2013

(54) SYSTEM AND METHOD FOR PRESENTING COMMENTS WITH MEDIA

(71) Applicants: Steven Friedlander, San Diego, CA (US); Sriram Sampathkumaran, San Diego, CA (US); William Schupp, San Diego, CA (US); David Young, San Diego, CA (US)

(72) Inventors: Steven Friedlander, San Diego, CA (US); Sriram Sampathkumaran, San Diego, CA (US); William Schupp, San Diego, CA (US); David Young, San Diego, CA (US)

(73) Assignee: Sony Corporation, Tokyo (JP)

(21) Appl. No.: 13/310,966

(22) Filed: Dec. 5, 2011

(51) Int. Cl. G06F 17/00

(52) U.S. Cl. 715/230

(57) ABSTRACT

A system and methods are provided for presenting a comment associated with presentation of media. In one embodiment, a method includes outputting media for display, and detecting a comment associated with the media based on a request for comments associated with the media, the request including identification of at least one user associated with a social network. The method may further include detecting a time code associated with the comment and outputting a graphical representation of the comment with presentation of the media based on the time code.

### FIELD

The present disclosure relates generally to electronic devices and methods, and more particularly to a system and methods for recording and presenting comments generated by users for media.

### BACKGROUND

Conventional systems for presentation of media typically do not allow for linking social networking to viewing of media. There exists a desire for sharing user comments related to media presentation. One current approach allows for graphical data to be embedded with video data. A drawback of this approach is that typically the data associated with the video is limited to that of the author, or one particular entity. An additional drawback is the inability to select graphical data or reactions from a selected source. Thus, there exists a desire for a system and methods which overcome one or more of the aforementioned drawbacks.

### BRIEF SUMMARY OF THE EMBODIMENTS

Disclosed and claimed herein are a system and methods for presenting a comment associated with presentation of media. In one embodiment, a method includes outputting media for display, and detecting a comment associated with the media based on a request for comments associated with the media, the request including identification of at least one user associated with a social network. The method further includes detecting a time code associated with the comment and outputting a graphical representation of the comment with presentation of the media based on the time code. Other aspects, features, and techniques will be apparent to one skilled in the relevant art in view of the following detailed description of the embodiments.

### BRIEF DESCRIPTION OF THE DRAWINGS

The features, objects, and advantages of the present disclosure will become more apparent from the detailed description set forth below when taken in conjunction with the drawings in which like reference characters identify correspondingly throughout and wherein:

FIG. 1 depicts a graphical representation of presentation of a comment according to one or more embodiments;

FIG. 2 depicts a process for presenting a comment associated with presentation of media according to one or more embodiments;

FIG. 3 depicts a simplified block diagram of a device according to one embodiment;

FIG. 4 depicts a simplified system diagram according to one or more embodiments;

FIGS. 5A-5B depict graphical representations of comment data presentations according to one or more embodiments;

FIG. 6 depicts a process for creating a comment according to one or more embodiments;

FIG. 7 depicts a graphical representation of a display window according to another embodiment;

FIG. 8 depicts a graphical representation of a user interface that may be displayed; and

FIGS. 9A-9B depict graphical representations of presenting of comment data according to one or more embodiments.

### DETAILED DESCRIPTION OF THE EXEMPLARY EMBODIMENTS

Overview and Terminology

One aspect of the disclosure relates to recording and presenting comments with media. A system and methods are provided for creating, selecting and presenting comments associated with media, where comments are generated by users of a device or application. According to one embodiment, comments may be presented with media by linking comments to time codes of the media.

A comment may relate to a graphical representation including one or more of text, image data, sound, and graphical data. Comments may be employed to provide a reaction or thoughts of a user when viewing media. Comments may include audio data, such as a sound recording of the user or selected audio data. In another embodiment, comments may provide marketing or product information associated with the media.

One embodiment of the disclosure is directed to an electronic device, such as a display device, that may be configured to present media, such as display of video data. The device may additionally be configured to request and/or detect comments associated with the media, and present the comments with the media. According to another embodiment, the device may be a media player configured to receive comments and present the comments in conjunction with presentation of media. Media, as used herein, may relate to one or more of video data, audio data, graphical data, image data, and audio/visual data in general.

In another embodiment, a system is provided for storing and presenting comments associated with one or more media titles. The system may allow for a device to present media and retrieve comments linked to the media based on one or more social connections.

Another aspect of the disclosure is directed to linking a social network to viewing of media. In one embodiment, user comments may be retrieved for media based on an association with a social network. Comments may be stored by a server for one or more users and retrieved based on selections in a users network with in the social network. A social network, or social networking application may relate to one or more of a blog, micro-blog, platform for network user profiles, and social network applications in general.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment,” “certain embodiments,” “an embodiment,” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics may be combined in any suitable manner on one or more embodiments without limitation.

In accordance with the practices of persons skilled in the art of computer programming, one or more embodiments are described below with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits.

When implemented in software, the elements of the embodiments are essentially the code segments to perform the necessary tasks. The code segments can be stored in a processor readable medium, which may include any medium that can store or transfer information. Examples of the processor readable mediums include an electronic circuit, a semiconductor memory device, a read-only memory (ROM), a flash memory or other non-volatile memory, a floppy diskette, a CD-ROM, an optical disk, a hard disk, a non-transitory medium, etc.

Exemplary Embodiments

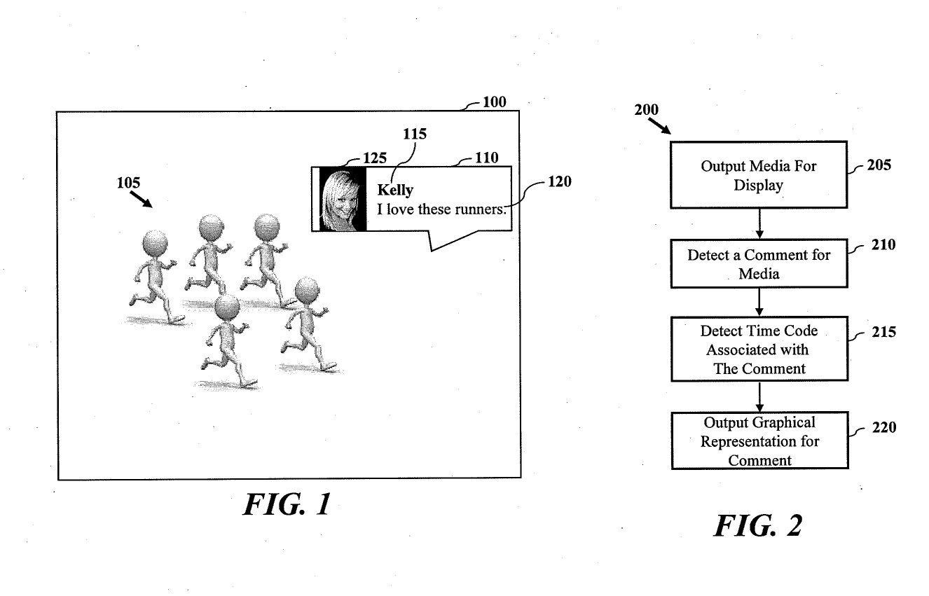

Referring now to the figures, FIG. 1 depicts a graphical representation of presenting a comment according to one or more embodiments. According to one embodiment, comments may be displayed with presentation of media, such as video content. FIG. 1 depicts a graphical representation of display window 100 including video content 105. Display window 100 may be employed to present media or video content 105 by a display device, such as a television, computer monitor, media player, etc. Video content 105 relates to an exemplary display of video content. Video content 105 in FIG. 1 may be associated with a particular frame and/or time code of the media. Although FIG. 1 is described with reference to video content, it should be appreciated that the embodiments discussed herein may be applied to other forms of audio/visual content.

A graphical representation of a comment is shown as 110 in FIG. 1. According to one embodiment, a system and methods are provided for presenting comments, such as comment 110 with media. Comment 110 may be displayed for one or more frames media, such as video content 105. For example, comment 110 may be displayed as overlaying a portion of display window 100. According to one embodiment, comment 110 may be linked to video content 105 based on a time code, such that the comment is presented with display of a particular set of frames of the video content. By presenting comment 110 based on a time code, the comment may be displayed with particular frames. An additional benefit may be the ability to present comments from one or more sources or authors with presentation of media. As used herein, media relates to presentation of audio/visual data, such as video, movie and digital content. However, it should also be appreciated that media may relate to one or more of audio, video, image data, and graphical displays. Another benefit may be provided based on the position comment 110 is presented relative to display window 100. Display of comment 110 may be based on a position identified by a user when the comment is created. In that fashion, comment 110 may be displayed in the position identified by the user, such that viewers may be notified of specific elements of video data 105.

According to another embodiment, systems and methods may be directed to linking a social network with media. In particular, an application may be provided for linking comments created by users of a social network to media. In that fashion, highly relevant messages may be presented with video content 105. In addition, a comment may be linked to media based on one or more associations within a social network. As will be discussed in more detail below, comments for media may be stored by a social networking application for each user. In that fashion, comment data may be provided to other users based on connections within the social network. Comments may incorporate one or more or features, or data, of a social networking application according to one or more embodiments.

Comment 110 is depicted as including name 115, text 120, and image 125. Name 115 may relate to the name of a user which created the comment and may be associated with a social network (e.g., profile or display name). Text 120 relates to text input by the user. Image 125 may relate to a profile image for a user that created the comment. Name 115 and image 125 may be received from a social networking server in association with receiving comment 110. In certain embodiments, display of name 115 and image 125 may be optional. As will be described in more detail below, system and methods are provided for creating, selecting and presenting comments with media.

Referring now to FIG. 2, a process is depicted for presenting a comment associated with presentation of media according to one or more embodiments. Process 200 may be employed by a device to present comments during presentation of media. In certain embodiments, process 200 may be performed by an application, such as one or more of an application for presenting media and an application for a social network.

Process 200 may be initiated by outputting media for display at block 205. Output of media at block 205 may include output of one or more of video data (e.g., video data 105), movie/film data, image data, graphical data and audio/visual data in general. Output of media at block 205 may be performed by a device, such as a display device or television. In another embodiment, output of media may be performed by a media player (e.g., video disc player, set-top box, gaming console, media player, etc.) configured to output media to a display device. Accordingly, process 200 is described with respect to a device, however, it should be appreciated that process 200 and the functions of process 200 may be preformed by an application executed by one or more devices.

At block 210, one or more comments may be detected for media. In one embodiment, comments may be created by a user of a device, such as a display device or media player, and stored by the device for later presentation. In that fashion, the device may be configured to detect comments for media based on comments stored by the device at block 210.

According to another embodiment, comments may be created and stored by an application, such as a social networking application, or application widget, during presentation of media. In this fashion, comments may be stored by a server of a social networking application, and may be retrievable based at least on one or more connections established in the social network. By way of example, comments may be displayed for a user based on user settings specifying one or more members of the user's social network. Accordingly, detecting a comment for media at block 210 may be based on one or more comments received from a server a network communication with a server, and one or more connections to a user within the social network.

Detecting comments for media at block 210 may be initiated by presentation or loading of media by a device. For example, a device may check for comments associated with media prior to playback and/or during playback. According to one embodiment, detecting a comment for media may include requesting comment data from a server. Requests for comments may identify particular media or video files for presentation. Comments detected at block 210 may be queued or stored for presentation during presentation of media.

At block 215, process 200 may detect a time code associated with detected comments. According to one embodiment, each comment may include a time code specifying one or more frames of the media. In that fashion, the comments may be presented in association with the one or more frames. According to one embodiment, a time code relates to the time associated with one or more frames of the media. A time code may be based on the timing system for presentation of media and include one or more of hours, minutes seconds and frames.

At block 220, a graphical representation may be output for a comment. In one embodiment, a comment may be displayed as a graphical element. Comments may be presented as an overlay to media in the display window, the overlay including one or more of text and image data. In certain embodiments, a comment may be displayed to include a graphical representation of a sound icon. For example, the comment may be displayed as a selectable icon, the selection of which may initiate playback of a recorded sound. The graphical representation of the comment may include one or more attributes of the user that created the comment including but not limited to a user name and image associated with a profile on a social network.

In certain embodiments, a device outputting the media and/or an application for presenting the comments may be configured to format display and presentation of comments. For example, graphical presentation of a comment may include formatting detected comment data to include a particular font, color, size, location, or other treatment. Personalization of the comment data may be based on user settings for a device that is configured to present the comments. In other embodiments, comments may include data for presentation based on attributes selected by the creator of the comment. For example, a comment (e.g., comment 110) may be displayed based on a position identified by a user when the comment is created to inform viewers of specific elements of video data and allow for discussion of the identified elements of portion of a display screen.

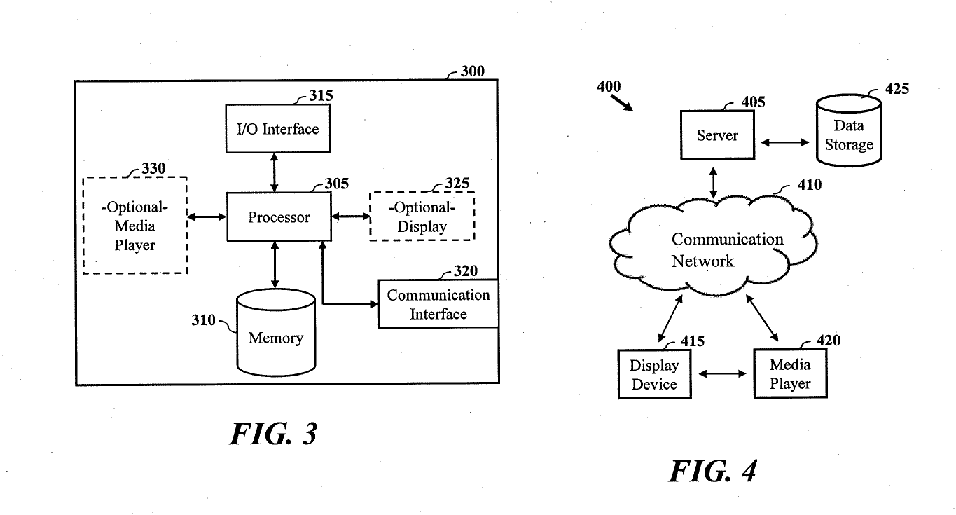

Referring now to FIG. 3, a simplified block diagram is depicted of a device according to one or more embodiments. Device 300 may relate to one or more of a display device, gaming console, personal communication device, media player, imaging device, or mobile electronic device in general. In certain embodiments, device 300 may be configured to output media for display. Alternatively or in combination, device 300 may be configured to output media and comment data to another device for display. In yet another embodiment, device 300 may be configured to provide an application for creating, detecting, and presenting comments. In another embodiment, device 300 may be configured to access a server to allow for network based storage and retrieval of comment and social networking data.

Device 300 may be one or more of a display device, set-top box, communication device, media player, gaming device or electronic device in general. Device 300 includes processor 305, memory 310, input/output (I/O) interface 315, and communication interface 320. Device 300 may optionally include display 325 and media player 330. Elements of device 300 may be configured to communicate and interoperate with processor 305 by a communication bus.

Processor 305 may be configured to control operation of device 300 based on one or more computer executable instructions stored in memory 310. In one embodiment, processor 305 may be configured to present one or more comments associated with presentation of media. Memory 310 may relate to one of RAM and ROM memories and may be configured to store one or more files, and computer executable instructions for operation of device 300. Although depicted as a single memory unit, memory 310 may relate to one or more of internal device memory and removable memory. Memory 310 may store one or more of audio and video files, and comment data.

Input output (I/O) interface 315 may be configured to output data and/or commands to one or more output devices. According to one embodiment, I/O interface 315 may be configured to receive one or more user commands. I/O interface 315 may include one or more buttons to control operation of device 300 including controlling selection of content for display and controlling operation of device 300. Input buttons of I/O interface 315 may include one or more buttons for user input, such as a such as a numerical keypad, volume control, menu controls, pointing device, track ball, mode selection buttons, and playback functionality (e.g., play, stop, pause, forward, reverse, slow motion, etc). Buttons of I/O interface 315 may include hard and soft buttons, wherein functionality of the soft buttons may be based on one or more applications running on device 300. I/O interface 315 may be configured to receive control commands from a remote control. I/O interface 315 may include a microphone or sound recording device to record audio data for comments.

Communication interface 320 may include one or more elements to for device 300 to communicate by wired or wireless communication. Communication interface 320 may include one or more ports for receiving data, including ports for removable memory. Communication interface 320 may be configured to allow for network based communications including but not limited to LAN, WAN, Wi-Fi, etc.

In certain embodiments, device 300 may relate to a display device and include display 325 to display media, such as video data, graphics data, guide data, comments and display one or more applications executed by processor 305. In certain embodiments, device 300 may relate to a media player and include media player 330 configured to read and output media, such as video data, digital video discs, etc.

Referring now to FIG. 4, a simplified system diagram is depicted according to one or more embodiments. System 400 can allow of linking comments to media according to one embodiment. As depicted in FIG. 4, system 400 includes server 405 configured for communicate with one or more of display device 415 and media player 420 via communication network 410.

Server 405 may be configured to receive and transmit comment data to display device 415 and media player 420 via communication network 410. According to one embodiment, server 405 may be configured to link an application, such as a widget, executed by one or more of display device 415 and media player 420 with data storage unit 425 associated with the social network. In that fashion, comment data from one or more users of the social network may be provided to one or more of display device 415 and media player 420. In addition to linking social network data and users to media, system 400 may additionally allow for providing marketing or advertisement data to media. For example, server 405 may be configured to provide relevant and directed advertisements for display with media. In addition, server 405 may be configured to allow for interactive presentation of data to display device 415 and media player 420 based on one or more user selections within presented comment.

According to another embodiment, display device 415 and media player 420 may be configured to communicate relative to each other to provide comment data. For example, in one embodiment, media player 420 may output media (e.g., video data, etc.) and comment data to display device 415. In another exemplary embodiment, display device 415 may be configured to present comments on media data received from media player 420. According to one embodiment, media is not required to be shared among devices to present comment data. One benefit of provided comment data based on a time code may be that comment data may be provided without modifying the file data of the media.

Communication network 410 may allow for one or more of wired and wireless communication and for network based communications including, but not limited to, LAN, WAN, WI-FI, etc. Devices 415 and 420 of FIG. 4 may be configured to connect to server 405 via communication network 410, which may include wired and/or wireless components. Although system 400 is described above as having a single server, it may be appreciated that system include a plurality of servers: Data storage unit 425 may relate to a database for storage of comment data.

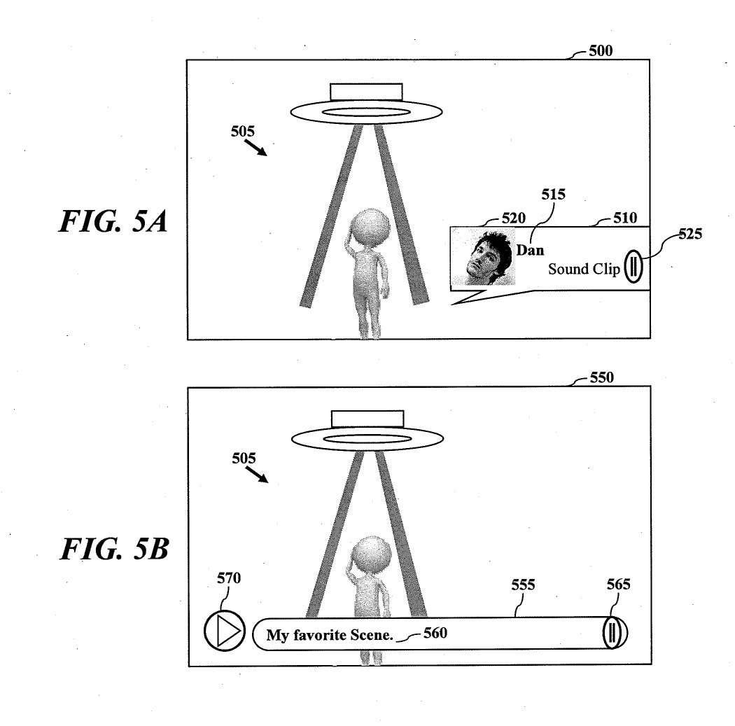

Referring now to FIGS. 5A-5B, graphical representations of presenting comment data are depicted. Referring first to FIG. 5A, presentation of a comment is depicted according to one or more embodiments. FIG. 5A depicts a graphical representation of display window 500 including video content 505. Display window 500 may be presented by a display device (e.g., television, computer monitor, media player, etc.) to present media, or video content 505. Video content 505 in FIG. 5A may be associated with a particular frame and/or time code.

Comment 510 is depicted as including name 515, image 520 and a graphical element 525 for a sound clip. Sound clip 525 may relate to sound data recorded by a user in response to video data 505. Presentation of comment 510 may include allowing for a user to select the graphical representation of sound clip 525 for playback. According to one embodiment, comments may be configured to store audio data for periods of up to one minute. However, it should be appreciated that other time periods may be allowed. Presentation of comment 510 allows for a user to receive commentary or reactionary responses by other users. As such, commentary may provide a richer experience and provide user reactions that may be shared by the social network. In addition, comments, such as comment 510 may be configured to provide commentary by actors or producers of media. Presentation of sound data for the sound clip 525 may be provided in conjunction with, or separate from, audio data associated with media, such as video data 505. Similar to the comment including text in FIG. 1, comment 510 may be presented to include name 515 and image 520 based on a profile name and profile image for a user that created the comment in the social network. Display position of comment 510 may be based on a position identified by a user when the comment is created. In that fashion, comment 510 may be displayed in a particular position of a display window for media. The position may be selected and/or identified by the user, such that specific elements of video data 505 may be identified. The position may be determined during creation of the comment and stored, such that display of the comment may be based on the stored position data for one or more comments.

Referring now to FIG. 5B, a graphical representation is depicted of a display window according to another embodiment. Display window 550 is depicted as including text bar 555. Text bar 555 may be displayed based on a command to create a comment. Based on the display of the text bar 555, the user may enter text for a comment as depicted by exemplary text 560. According to one embodiment, text bar 555 may include display of graphical icon 565 which may be selected by the user to initiate recording of sound for the comment. According to one embodiment, when a command is detected to create a comment, the device or application, controlling display of the media, may pause presentation of the media. Any data entered for the comment may then be associated with the particular point of media as pause based on a time code. The time code may specify the particular frame associated with the user input to create a comment and identify a particular amount of time or frames which follow to be included in the time code. The comment may then be later presented based on the duration set for the time code. Once the comment data has been received, the user may select icon 570 which may initiate playback of video data 505 and save comment data with a time code for at least frames of vide data 505. Accordingly, the device or application controlling the playback may terminate the display of text bar 555.

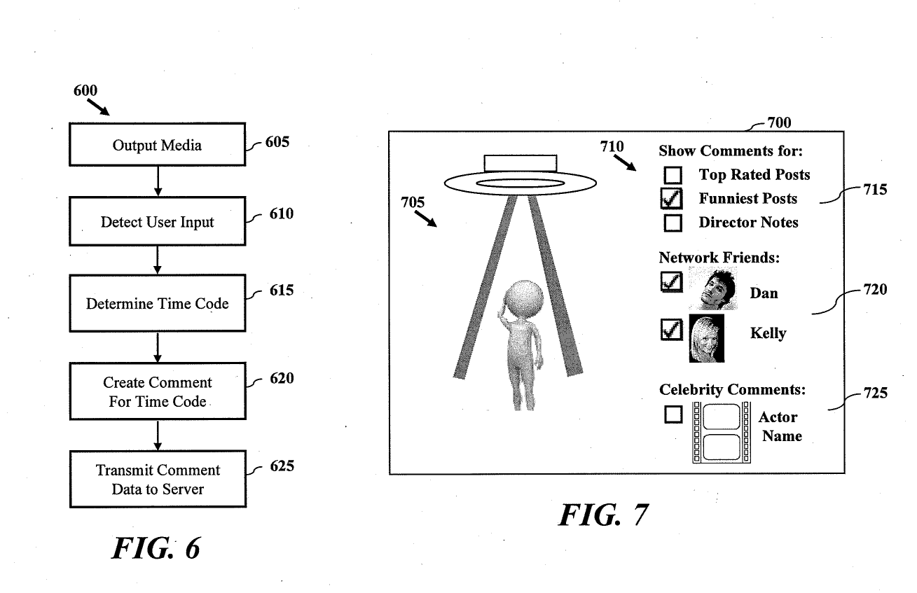

Referring now to FIG. 6, a process is depicted for creating a comment according to one or more embodiments. Process 600 may be employed to associate comments with media being presented by one or more of a display device and media player. For example, a device (e.g., display device 415, media player 420, etc.) may be programmed to execute an application. The application may be interoperated with or as an addition to programming for operation of the device. The device may be configured to create, record, request and/or display comments from a user. In one embodiment, the comments may be linked to media based on a time code. According to another embodiment, comments may be linked and/or presented based on one or more connections within a social network. Although the process in FIG. 6 is discussed as being performed by a device, it should be appreciated that similar features may be incorporated in and executed by an application.

Process 600 may be initiated at block 605 by outputting media, such as for example outputting media for display on a display device. The device may be configured to present the media and allow for a user to input a command to enter a comment. In one embodiment, the command may be based on operation of a remote control, such as activation of a hard or soft button. The device may detect the user input at block 610. At block 615, the device may store a mark associated with the time code or frame of the media. In some embodiments, the device may pause playback of the media. In other embodiments, the device may continue playback and allow for a user to enter text and/or other attributes for the comment at a later time.

In certain embodiments, the user input at block 610 and/or marking the time code of media at block 615 may initiate display of a text bar or box to allow a user to enter text and/or sound data for the comment. Based on data detected from a user, the device may create a comment for the media associated with the time code at block 620. Data associated with the comment may be transmitted to a server at block 625. For example, the data may be transmitted including an identification of the media, the comment data, time code and information identifying a user of the social network. Accordingly, the server may be configured to store the data associated with the comment for later retrieval. Transmitting data at block 625 may include posting comment data to a social network.

Referring now to FIG. 7, a graphical representation is depicted of a display window according to another embodiment. Display window 700 is depicted as including media, such as video data 705 and listing 710. Listing 710 may be presented to allow a user to specify comments for display during presentation of media.

According to one embodiment, listing 710 may be displayed prior to, or during, display of media. Listing 710 can be employed by a user to select comments from one or more network associations. According to another embodiment, comments may be received based on ratings for comments, such as highest rated comments, and humor to select the funniest posts as depicted in selection area 715 of list 710. A selection tab may also be selected for director notes and/or other production notes, such as film facts. Section 720 of list 710 may allow for selection for comments by one or more friends. Section 725 may allow for selection of comments from one or more celebrities. Celebrity comments may be based on comments provided by a social network or content of the media. It may be appreciated that the celebrity comments may be from actors within a title or celebrities in general. Listing 710 may be a scrolling list to allow for viewing and selection of additional comment sources.

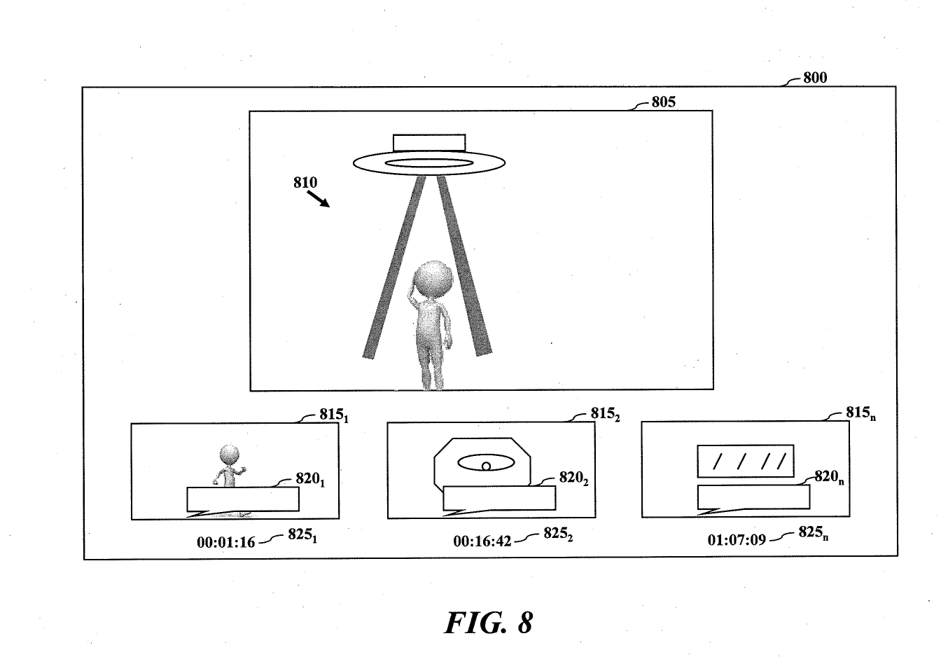

According to another embodiment, a user interface may be presented for reviewing selected portions of video data (e.g., frames) and entering comments. Referring now to FIG. 8, a graphical representation is depicted of a user interface that may be displayed. Display window 800 may be displayed by a device to include media window 805 providing a display of media, such as video data 810. Based on one or more user selected time codes of media, selected time frames 815₁₋ₙ may be displayed within display window 800. Time frames 815₁₋ₙ may relate to an image or series of images displayed to identify a particular portion, such as a scene, dialogue, and/or sounds, of the media. Time frames 815₁₋ₙ may be displayed including a graphical representation of text bars 820₁₋ₙ which may be selected for a user to enter a comment. Each of time frames 815₁₋ₙ may also be displayed including a time code of the particular frame, such as time codes 825₁₋ₙ.

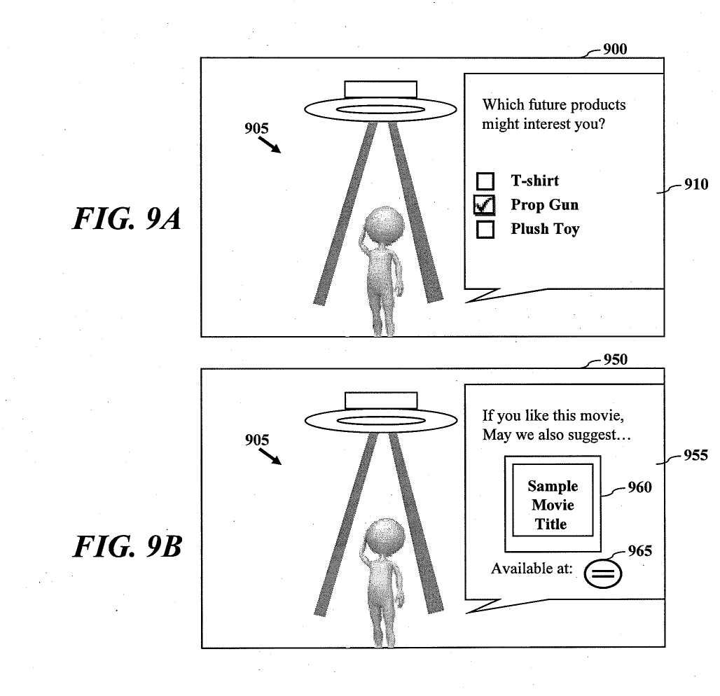

Referring now to FIGS. 9A-9B, graphical representations are depicted of presenting of comment data including advertisement or marketing information. Referring first to FIG. 9A, presentation of a comment is depicted according to one or more embodiments. Display window 900 includes video content 905 and comment 910. Comment 910 includes one or more selectable boxes directed at receiving user feedback relative to video content 905. Comment 910 may be presented based on a time code for video content 905.

Referring now to FIG. 9B, a graphical representation is depicted of a display window according to another embodiment. Display window 950 includes video content 905 and comment 955. Comment 955 includes a suggested movie title 960. User selection of graphical icon 965 may direct the user device to a network accessible location for download and/or purchase of the move title identified.

While this disclosure has been particularly shown and described with references to exemplary embodiments thereof, it will be understood by those skilled in the art that various changes in form and details may be made therein without departing from the scope of the embodiments encompassed by the appended claims.

What is claimed is:

1. A method for presenting a comment associated with presentation of media, the method comprising the acts of:
outputting media for display;
detecting a comment associated with the media based on a request for comments associated with the media, the request including identification of at least one user associated with a social network;
detecting a time code associated with the comment; and
outputting a graphical representation of the comment with presentation of the media based on the time code.

2. The method of claim 1, wherein outputting media includes output of one or more of video data, audio data, movie data, and audio/visual data.

3. The method of claim 1, wherein outputting media includes at least one of display of media by a device and output of the media to a device.

4. The method of claim 1, wherein the comment is linked to the media by a server based on the time code.

5. The method of claim 1, wherein detecting a comment includes determining one or more comments based on one or more selected users of a social network.

6. The method of claim 1, wherein the time code identifies one or more frames of the media.

7. The method of claim 1, wherein the comment includes at least one of text, image data, and audio data for output with the media.

8. The method of claim 1, wherein the comment includes marketing data for one or more of suggesting media, suggesting products and presenting marketing information.

9. The method of claim 1, wherein outputting a graphical representation of the comment is performed during display of the media.

10. The method of claim 1, wherein outputting a graphical representation of the comment includes display of the comment associated a position within a display of the media, the position determined during creation of the comment.

11. The method of claim 1, further comprising transmitting a request to a server for comments linked to the media based on a user profile with a social network.

12. A system comprising:
a server configured to store comments for media for a plurality of users of a social networking service; and
a device configured to output media, the device configured to communicate with the server and to:
output media for display;
detect a comment associated with the media based on a request to the server for comments associated with the media, the request including identification of at least one user associated with a social network;
detect a time code associated with the comment; and
output a graphical representation of the comment with presentation of the media based on the time code.

13. The system of claim 12, wherein output of media includes output of one or more of video data, audio data, movie data, and audio/visual data.

14. The system of claim 12, wherein output of media includes at least one of display of media by a device and output of the media to a device.

15. The system of claim 12, wherein the comment is linked to the media by a server based on the time code.

16. The system of claim 12, wherein detecting a comment includes determining one or more comments based on one or more selected users of a social network.

17. The system of claim 12, wherein the time code identifies one or more frames of the media.

18. The system of claim 12, wherein the comment includes at least one of text, image data, and audio data for output with the media.

19. The system of claim 12, wherein the comment includes marketing data for one or more of suggesting media, suggesting products and presenting marketing information.

20. The system of claim 12, wherein output of a graphical representation of the comment is performed during display of the media.

21. The system of claim 12, wherein output of a graphical representation of the comment includes display of the comment associated a position within a display of the media, the position determined during creation of the comment.

22. The system of claim 12, further comprising transmitting a request to the server for comments linked to the media based on a user profile with a social network.

23. A method for presenting a comment, by an application, associated with presentation of media, the method comprising the acts of:
detecting output of media for display;
generating a request for comments associated with the media to a server, the request including identification of at least one user associated with a social network;
detecting a comment based on the request;
detecting a time code associated with the comment; and
outputting a graphical representation associated with the comment based on the time code with presentation of the media.

24. The method of claim 23, wherein outputting media includes output of one or more of video data, audio data, movie data, and audio/visual data.

25. The method of claim 23, wherein outputting media includes at least one of display of media by a device and output of the media to a device.

26. The method of claim 23, wherein the comment is linked to the media by a server based on the time code.

27. The method of claim 23, wherein detecting a comment includes determining one or more comments based on one or more selected users of a social network.

28. The method of claim 23, wherein the time code identifies one or more frames of the media.

29. The method of claim 23, wherein the comment includes at least one of text, image data, and audio data for output with the media.

30. The method of claim 23, wherein the comment includes marketing data for one or more of suggesting media, suggesting products and presenting marketing information.

31. The method of claim 23, wherein outputting a graphical representation of the comment includes display of the comment associated a position within a display of the media, the position determined during creation of the comment.

32. The method of claim 23, wherein outputting a graphical representation of the comment is based on the position of the comment identified during creation of the comment.
